(19) United States
(12) Patent Application Publication
(10) Pub. No.: US 2008/0121123 A1
(43) Pub. Date: May 29, 2008

(54) Stamping tool in a printing mechanism with a matrix and punch

(75) Inventor: Rainer Gebhardt, Offenbach (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/985,314

(22) Filed: Nov. 14, 2007

Related U.S. Application Data
(63) Continuation of application No. PCT/EP2006/000499, filed on Jan. 20, 2006.

(30) Foreign Application Priority Data
Jan. 21, 2005 (DE) 10 2005 003 146.3
Aug. 9, 2005 (DE) 10 2005 037 492.1

(51) Int. Cl. B31F 1/07; B44B 5/02

(52) U.S. Cl. 101/24; 101/32; 101/30

(57) ABSTRACT

A process for affixing an embossing arrangement to a printing press having opposing first cylinder and second cylinder is disclosed. The embossing arrangement includes an embossing tool and an opposing tool. The process includes the steps of mounting the embossing tool and the opposing tool together on the first cylinder; making a surface of the opposing tool which faces away from the first cylinder a pressure-sensitive adhesive surface; and positioning the opposing tool on the second cylinder by rolling the first cylinder over the second cylinder. An embossing arrangement and a photopolymer embossing plate are also disclosed.

### CROSS-REFERENCE TO RELATED APPLICATIONS

This is a continuation of International Application No. PCT/EP2006/000499, filed on Jan. 20, 2006. Priority is claimed from German Patent Application Nos. 10 2005 003 146.3, filed on Jan. 21, 2005, and 10 2005 037 492.1, filed on Aug. 9, 2005.

### BACKGROUND OF THE INVENTION

1. Field of the Invention

The invention relates to a device, a process, and a photopolymer embossing form for improving the execution of embossing work in printing processes.

2. Description of the Related Art

It is known that embossing work can be carried out in printing couples. It is thus possible to link an enhancement of the printed product with the printing process within a printing press. This type of work is also frequently carried out outside the printing press, i.e., in downline processes. Embossing operations have usually been conducted off-line in the past. Only work such as grooving, punching, or perforating have been conducted in the printing press itself.

It is known from DE 41 38 278 C2 that a device for punching, grooving, and perforating in sheet-fed printing presses can be used in a coating module of a sheet-feed printing press. For this purpose, an appropriate tool is attached to the form cylinder of the coating module. The tool works against the sheet resting on the corresponding impression cylinder. The disadvantage here is that most printed products must be coated, and thus the optional use of the coating module can be used for only a very small percentage of printing orders.

What is described here is embossing or grooving in a printing press with double-wide impression cylinders and a protective covering on the impression cylinder. In the case of either raised or indented embossing, it is never possible to use more than one embossing or grooving form, which is clamped onto the form cylinder of the printing press.

Another embossing device is known from DE 198 26 974 A1. Here, a so-called “blind embossing” process is again carried out in a coating module or a printing couple. An embossing plate which is patterned over its entire surface and which works against an elastic impression element is used.

A device on a printing press for perforating, punching, cutting, grooving, and partial coating or for the printing of envelopes is also known from EP 0 862 774 B1. In this device, tools can be attached to a plate, which can be clamped to a cylinder of a printing press. The tools are positioned on the corresponding plate and held in place there by their self-adhering backs. A protective film is provided on the opposing cylinder while the sheet is being processed in the printing press.

East German Patent DD 231 760 describes a process for embossing in sheet-fed offset printing presses, in which a bimetal plate (die) suitable for embossing is bonded with an adhesive to the impression cylinder of a printing press, and a blanket on a blanket cylinder of a printing couple or on the form cylinder of a coating unit serves as the matrix. This type of application suffers from the significant disadvantages that the adhesive bonding of a plate of this type to the impression cylinder involves very complicated work and that it is very difficult to correct the register later. Another disadvantage in the case of printing presses with double-wide impression cylinders is that two dies must be mounted with a high degree of positional accuracy on the impression cylinder. In addition to the high cost of preparing two dies, at least twice the set-up time must be estimated for the installation of the die plates.

DE 201 11 983 U1 describes a printing press in which a special protective foil protects the impression cylinder against the mechanical effects of the forming tools. The disadvantage here is that raised embossing is not possible, because for this purpose the embossing form would have to be located on the impression cylinder.

References to protective devices for cylinders of printing presses can be found in DE 198 26 974 C2 and DE 102 11 991 A1. Each of these documents describes the use of protective foils on either the impression cylinder or on the form cylinder, depending on whether raised or indented embossing is desired. The disadvantage again is that, in the case of raised embossing in a printing press with double-wide impression cylinders, two forms must be installed with positional accuracy on an impression cylinder.

DE 44 35 307 C2 describes a process and a device for perforating, punching, and embossing. The goal is to process the substrate mechanically in the printing press before the actual printing process itself is carried out. This eliminates the problem of ink being deposited on the forming tools, because the substrate is perforated or embossed, for example, before it is printed. Nevertheless it is still a problem that the embossings are at least partially flattened out again as the substrate passes through the following printing couples and is printed.

East German Patent DD 95 851 describes a sheet-fed rotary printing press in which a punching mechanism is connected to the sheet-fed rotary printing press by way of a clutch. Similar solutions for connecting punching mechanisms to sheet-fed presses are also known from U.S. Pat. No. 3,832,944, DE 20 2004 018 764 U1, and DE 20 2004 018 763 U1. The disadvantage of all these solutions is that the punching mechanisms are expensive separate assemblies and thus tend to interfere with the operation of printing presses not equipped for mechanical processing of the substrate.

Various materials are known to be used in the production of embossing forms. Photopolymer plates are best known from the flexographic printing process and from letterpress printing. The necessary relief on these plates is produced by exposing them to light and then removing the unexposed plate material by the use of a suitable device. A different production method is gravure, where the unwanted plate material is removed by laser gravure or some other suitable gravure method. These types of plates can be used very advantageously for the embossing of paper, paper composites, plastic films, and metal foils. A matrix form carries recesses, which receive the embossing motif of the corresponding die form.

In embossing, a distinction is usually made between raised embossing (the embossed relief projects above the surface of the substrate) and indented embossing (recessed areas are embossed into the substrate). The embossing form which carries raised embossing elements is called the die. The opposing form, which carries the recesses, is called the matrix. In some cases, opposing forms which have elastic or other deformable properties but no recesses are called matrices. The matrix is thus in general the counterpart to the die. Most applications require raised embossing, especially when the information is to be conveyed by haptic means (tactile, detected by touch) as is the case with Braille.

For embossing work with complicated motifs, no process of embossing integrated into a printing press has yet been described. The experts in the field have been held back from such embossing, because in particular the so-called register work becomes much more complicated. It is obvious that, in the case of complex three-dimensional patterning, the accuracy of the two embossing elements, i.e., the die and the matrix, must be much higher than in the case of, for example, a simple grooved line.

### SUMMARY OF THE INVENTION

An object of the invention is therefore to create a device, an embossing form, and a process for improving the execution of embossing work in printing presses. The object is accomplished by a process for affixing an embossing arrangement to a printing press having opposing first cylinder and second cylinder, the embossing arrangement comprising an embossing tool and an opposing tool, the process comprising the steps of mounting the embossing tool and the opposing tool together on the first cylinder; making a surface of the opposing tool which faces away from the first cylinder a pressure-sensitive adhesive surface; and positioning the opposing tool on the second cylinder by rolling the first cylinder over the second cylinder. The object is also accomplished by an arrangement for embossing in a printing press having a blanket/form cylinder and an impression cylinder, the arrangement comprising an embossing tool; an opposing tool; a plate mounted on the blanket/form cylinder and carrying the embossing tool; and an opposing plate removably mounted on the impression cylinder and carrying the opposing tool. The object is also accomplished by a process for installing a photopolymer embossing plate in a device, the photopolymer embossing plate comprising a die form having embossing motifs and alignment elements, and a matrix form having corresponding recesses on one side and an adhesive surface on the other side, the process comprising the steps of engaging the die form with the matrix form by positioning the embossing motifs and the alignment elements of the die form in the respective recesses of the matrix form; mounting the matrix form on a first cylinder of the device so that the adhesive surface of the die form faces away from the first cylinder.

A simplified method for installing embossing forms in a printing press is created by the combination of steps consisting of the attachment of a three-dimensional embossing form to the surface of a cylinder and the transfer of that form to the opposing cylinder, on which a retaining plate is provided, by a rolling process.

The device is advantageously designed in that the support surface for the lower embossing form (matrix) is provided in the form of a plate, which can be mounted on the appropriate cylinder. The plate can be made of metal or plastic foil. Thus, once the plate is appropriately positioned on the cylinder, the embossing form in question can be attached to the cylinder again any number of times with equal positional accuracy.

It is advantageous for an embossing form which can be used in the process and in the device to have appropriate connecting elements for the two parts of which the embossing form consists, so that it is easy to install them both in their exact positions.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in greater detail below on the basis of the drawings. In the drawings:

FIG. 1a shows a cross section through a processing couple;

FIG. 1b shows a cross section through another processing couple;

FIG. 2 shows a schematic diagram of an embossing form;

FIG. 3 shows a first schematic diagram of an inventive installation of an embossing form;

FIG. 4 shows a second schematic diagram of an inventive installation of an embossing form; and

FIG. 5 shows another arrangement for the installation of an embossing form.

### DETAILED DESCRIPTION OF THE PREFERRED EMBODIMENTS

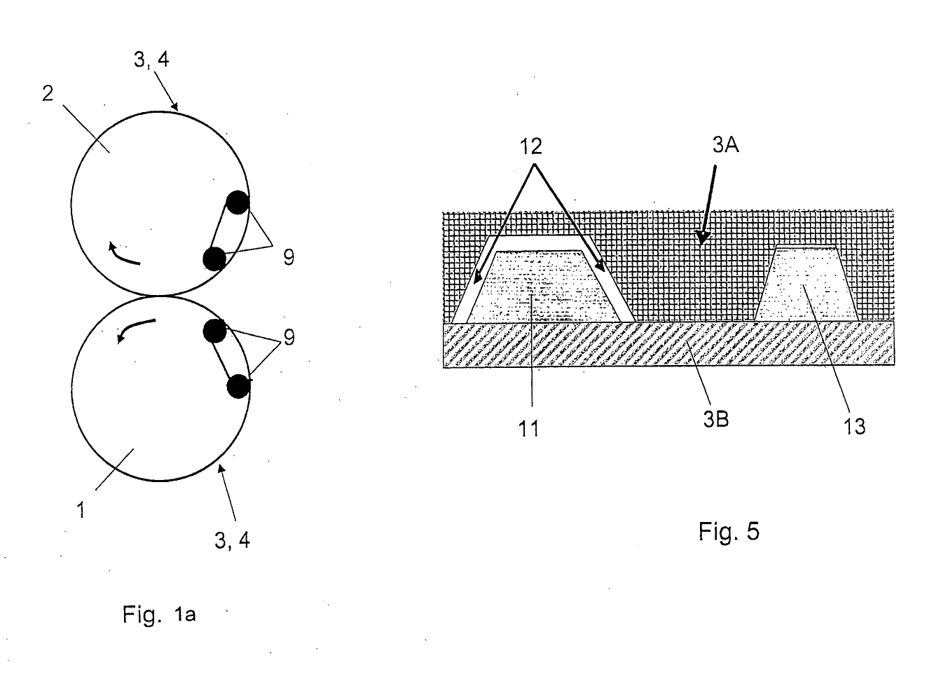

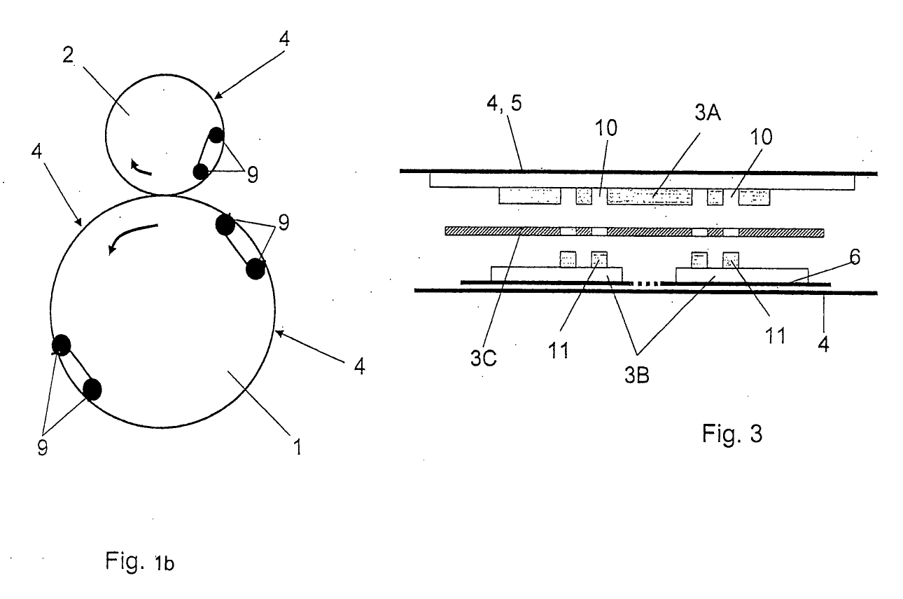

As shown in FIG. 1a, an impression cylinder 1 and an opposing blanket cylinder or form cylinder 2 are arranged to form a processing couple of a sheet-fed printing press. A sheet to be processed is guided by gripper devices on the impression cylinder 1. Printing plates or blankets are usually mounted on the form cylinder 2 or blanket cylinder. In the case of embossing, an embossing form 3 is mounted on the appropriate cylinder. This can be a positive or a negative embossing form (die, matrix). The embossing form 3 can be arranged on a packing plate 4 and can be clamped by means of that to the form cylinder 2 or blanket cylinder.

FIG. 1b shows a diagram of another processing couple of a sheet-fed printing press. This processing couple has a so-called double-wide impression cylinder 1, which is provided with two working surfaces and a corresponding plurality of clamping devices 9. The embossing forms 3 or packing plates 4 are attached to the form cylinder 2 or blanket cylinder and to the working surfaces of the impression cylinder 1.

Depending on the embossing process, the embossing form 3 can be used to emboss a motif against a soft impression surface. By means of a process of this type, however, only simple motifs can be embossed.

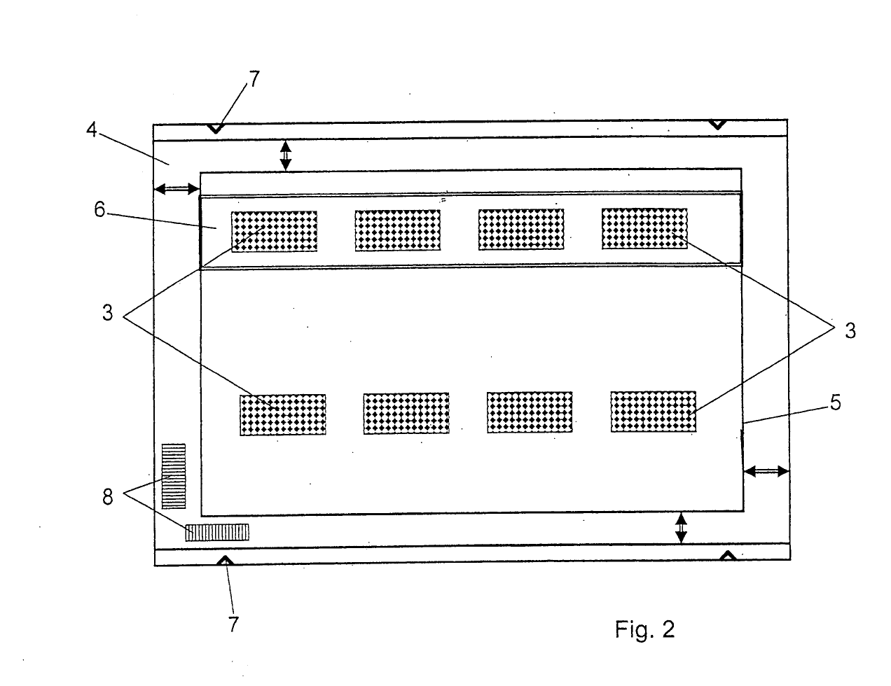

Much more complicated motifs of high quality can be produced by embossing with an embossing form 3 consisting of an upper embossing form 3A and a lower embossing form 3B. A diagram of an embossing form of this type is shown in FIG. 2.

As shown in FIG. 2, the device thus has a packing plate 4, which can be mounted on an impression cylinder 1. For this purpose, clamping devices 9 are provided on the impression cylinder 1 (see FIGS. 1a and 1b). Thus, after completion of the order, the packing plate 4 can be unclamped together with the tool (i.e., the upper or lower embossing form) from the impression cylinder 1 and used again.

So that it is easier to match up the tool with the opposing tool on the form cylinder 2 when the tool is to be used again, the position of the tool can be recorded; that is, it can be marked manually or measured by an appropriate position sensor. This configuration can then be used for a repeat order; that is, the corresponding settings can be used again to set up the press, and the press can be put back into operation again after the shortest possible set-up time. The positional accuracy between embossing and printing is achieved by register adjustments to the printing couple.

The packing plate 4 has register punchings 7 in a clamping area. A flat register frame 5, which is arranged with freedom to shift position with respect to the packing plate 4, can be provided on the packing plate 4. Thus the register frame 5 can be positioned relative to the surface of the form cylinder 2 or impression cylinder 1 or the clamping devices 9 or the register punchings 7.

The embossing form 3 can now be arranged on the surface of the register frame 5 or directly on the corresponding packing plate 4. The embossing form 3 can be taken apart into its individual elements. Several individual elements can in turn be combined into an embossing form segment to simplify the installation. For this purpose, the individual elements of the embossing form 3 can be premounted on a base form 6 or combined into a base form 6. This will be useful especially in cases where the embossing form 3 is arranged in linear fashion in a direction parallel to the axis of the cylinder in question. Especially in cases where individual elements of the embossing from 3 are distributed around the circumference of the cylinder, however, it will be preferable for cost reasons to split the embossing form 3 into individual elements to simplify their installation and also in particular to lower the cost of producing the embossing form 3 itself. A scale 8, which simplifies the alignment of the register frame 5 with the embossing form 3, can be provided on the packing plate 4.

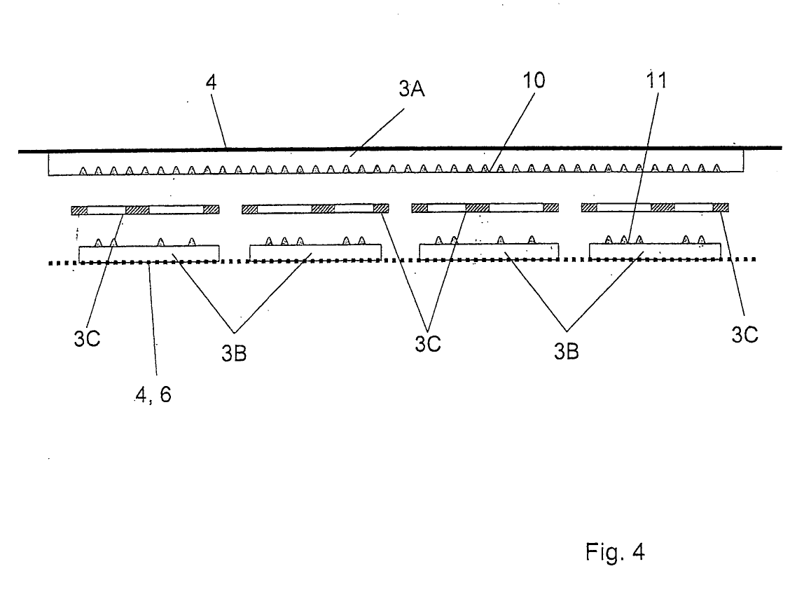

FIGS. 3 and 4 show the structure of an embossing tool consisting of an upper embossing form 3A and a lower embossing form 3B.

The embossing form 3A is attached to a packing plate 4. The upper embossing form 3A has matrix elements 10 in the form of recesses conforming to the contour to be embossed. The lower embossing form 3B is divided into two individual elements, which carry the die elements 11 in the form of elevations corresponding to the matrix elements 10. The individual elements of the lower embossing form 3B can be attached separately to a packing plate 4. It is also possible, however, to provide the base form 6 described above for the attachment of the individual elements to the packing plate 4.

As an intermediate layer to simulate the substrate to be processed later on, an auxiliary foil 3C is provided between the upper and lower embossing forms 3A and 3B. If the lower embossing form 3B has been split into individual elements, the auxiliary foil 3C can also be divided into parts in the same way. The auxiliary foil 3C has openings, which correspond either to the individual die elements 11 or to groups of them. The auxiliary foil 3C can have adhesive properties on both sides. When the lower embossing form 3B is placed against the upper embossing form 3A by way of the auxiliary foil 3C, the die elements 11 will therefore pass through the openings in the auxiliary foil 3C and can be aligned with the matrix elements 10 in the embossing form 3A. The auxiliary foil 3C attaches the embossing forms 3A and 3B to each other but in a detachable fashion.

Alternatively, latch elements can be provided on the upper and lower embossing forms 3A and 3B (see FIG. 5), which can be used to align the upper and lower embossing forms 3A, 3B with each other and to fasten them together. The auxiliary foil 3C in this case can serve as a spacer.

To install the embossing form 3, a package is first formed out of the two embossing form parts 3A and 3B. The upper and lower embossing form parts 3A and 3B can be attached to each other by means of self-adhering elements, mechanical elements, or latching elements (see also FIG. 5). As a result, it is ensured that the parts 3A and 3B of the overall embossing form 3 will remain aligned precisely with each other. For installation, the package consisting of the upper and lower embossing form parts 3A and 3B is now mounted in the desired position on, for example, the upper cylinder (form cylinder 2 or blanket cylinder). For this purpose, either a packing plate 4 or a register frame 5 (see FIG. 2) mounted on that plate can be used. A scanning pattern can be provided on the element in question. The scanning pattern advantageously provides reference points for the exact positioning of the upper and lower embossing form parts 3A, 3B. For the sake of later adjustment, it is possible for the corresponding cylinder (form cylinder 2) to be provided with a register device so that it can be shifted with respect to the adjacent cylinder (impression cylinder 1).

So that the upper embossing form, e.g., form part 3A, can be mounted on the upper cylinder (form cylinder 2), the rear surface of the form is provided with a layer of pressure-sensitive adhesive. After the upper and lower embossing forms 3A and 3B have been assembled into a package and attached to the upper cylinder (form cylinder 2), the pressure-sensitive or self-sticking adhesive layer on the outward-facing surface of the upper and lower embossing form 3A or 3B must be activated. Then a rolling operation is carried out between the cooperating cylinders (form cylinder 2, impression cylinder 1). The contact pressure between the two cylinders must be selected so that the upper and lower embossing forms 3A, 3B are not crushed. During the rolling operation, the lower embossing form (here: 3B) automatically positions itself on the surface of the lower cylinder (impression cylinder 1). The lower embossing form 3B will now stick to the surface of the lower cylinder and separate itself from the upper embossing form 3A. It is important here for the pressure-sensitive adhesive layer to have sufficient adhesive force to allow the connection between the upper and lower embossing forms 3A, 3B to be separated without displacement of their relative positions.

The sequence of steps is as follows:

1. Clamp the tool (packing plate 4 with embossing form 3 installed on it) to the form cylinder 2. It is also possible to use a photopolymer plate, as known from resin coating, of suitable hardness.

2. If necessary, adjust the embossing form 3 to fit a given printed image. This can be done by shifting the packing plate 4, by shifting the embossing form 3 by means of the register frame 5 on the packing plate 4, or by adjusting the register of the cylinder (form cylinder 2).

3. Mount the opposing tool (lower/upper embossing form 3A, 3B) on the blanket or form cylinder 2 on top of the previously adjusted, corresponding tool (upper/lower embossing form 3B, 3A), possibly with the use of underpacking (e.g., auxiliary foil 3C) between the two embossing forms (3A, 3B). Auxiliary means, i.e., alignment elements, e.g., cones 13 (see FIG. 5) with counter-elements on the embossing forms (3A, 3B), can also be used. Dividing the form into several segments makes it easier to handle and to adjust the deformation, i.e., curvature, of the embossing form 3B to be attached to the impression cylinder 1.

4. Activate the pressure-sensitive adhesive foil (or possibly a magnetic foil) on the rear surface of the outer tool of the tool package (upper or lower embossing form 3A or 3B) (by removing the protective film, heating, etc.).

5. Under defined pressure contact conditions, roll the tool package consisting of the upper and lower embossing form parts 3A and 3B over the impression cylinder 1 to separate the base tool from the opposing tool and to transfer it by adhesion to the impression cylinder 1. The opposing tool (upper or lower embossing form 3A or 3B) is now attached to the opposing cylinder in the correct position. The auxiliary foil 3C can be pulled off the lower tool (embossing form 3B, die) without leaving any residue behind.

6. Repeat steps 3-5 as often as necessary for a double-wide or triple-wide impression cylinder 1, that is, one with two or three working surfaces (see FIG. 1a), so that the cylinder 1 is provided with the appropriate number of opposing tools.

As sketched in FIGS. 3 and 4, the first three steps can also be combined into two steps as follows:

1. Outside the printing press, the tool package is assembled from the following components:

a. a raised embossing form (e.g., photopolymer plate) or embossing form 3A, mounted on the packing plate 4 for the form cylinder 2; suitable for conventional clamping devices 9; this can be the matrix if Braille text is to be produced;

b. a sheet of auxiliary film 3C with the same thickness as the substrate to be processed; this can be provided with an adhesive layer (e.g., a film of low adhesive strength) on both sides so that the two embossing forms 3A, 3B can be attached to each other; openings are cut out for the embossing elements to ensure flush attachment; the same is also true for Braille forms;

c. the opposing tool in the form of embossing form 3B for the impression cylinder 1. Attach the packing plate 4 (e.g., photopolymer on a plastic backing), also as segmented embossing forms 3B (extending approximately 150 mm in the circumferential direction) to the embossing form(s) previously mounted in accordance with steps 1.a and 1.b; use alignment elements to align the segments of the embossing form 3B by optical or mechanical means.

2. Mount the entire package consisting of the embossing forms 3A, 3B and the auxiliary film 3C (possibly with an packing plate 4, possibly with a register frame 5, possibly with a base form 6) on the form cylinder 2 by means of clamping devices 9; if mounting standards are good, a positional accuracy of 1-2 mm can be obtained for offset printing.

The process according to step 2 can be conducted with the use of a device for semi- or fully automated plate clamping and thus can be completed much more quickly.

With this device there is also the possibility of providing for the semi-automatic or fully automatic changing of the embossing forms 3A, 3 B an/or the plates on the blanket/form cylinder 2 or the impression cylinder 1. Thus, instead of a printing plate changing device, an impression plate changing device will be used. It therefore becomes possible to vary the function of the impression cylinder 1 by changing, for example, the support plates on the impression cylinder 1.

The following can be used:

a. cylinder jackets for high-quality B&W printing;

b. structured chromium plates for standard B&W and aggressive substrates;

c. chromium plates as protection for standard applications;

d. embossing plates for structured embossings;

e. embossing plates for high-quality blind embossing with die and matrix;

f. cylinder jackets with modified surfaces for defined structured images in new straight printing and perfecting.

Underpackings should be provided on both cylinders to adjust the rolling relationships in cases of cylinders of different sizes or even in the case of cylinders of the same size. In a first variant, the underpacking sheets can be adjusted by means of clamping rails or foils under the surface of the cylinder. For this purpose, a so-called jacket surface is provided on the cylinder. In a second variant, a calibrated sheet can be pulled onto the cylinder from a corresponding cassette in automated fashion.

The system can be enhanced through the possibility of registering the clamped-on packing plate 4 in both the circumferential and lateral directions. This can be done by means of the clamping device 9 or by means of the impression cylinder 1. Alignment systems with scanning devices using position sensors ensure reproducible handling.

To provide for effective automation and to reduce the setup times for high-quality blind embossing, including perforating, punching, and grooving, the adjustments of the offset printing form, the form cylinder tool, and the impression cylinder tool with respect to each other can be linked in an intelligent evaluation unit.

The following procedure can be used for this purpose:

1. Adjust the punching tools by providing the two embossing forms 3A, 3B, possibly divided into several panels, with passive or active transmitting elements. This makes it possible to identify the forms and to determine their positions. An evaluation unit can subject the signal indicating “agreement”, i.e., release for printing, or the signal indicating “correction required”, i.e., wrong opposing tool or wrong position, to further processing. Thus the operator is given suitable information, on the basis of which he can make further adjustments to position of the tool. Signals indicating displacements in all directions are also conceivable, and signals proportional to the extent of the deviations could also be generated.

2. The position of an offset printing form provided for blind printing can be detected by way of a punching, that is, adjusted with respect to the edge of the format, and used for positioning of the embossing tool 3. For this purpose, the embossing form 3 must have a punching in the exact location required.

3. As an alternative, a transmitting element, the signals of which are evaluated in accordance with Point 1, can be provided in the offset printing press.

The advantages of this process and of this device are a high degree of positional accuracy of the embossing as a result of the positive action of the grippers within the sheet-fed offset printing press. In the case of an in-line process, one step, i.e., a step which usually has to be performed at a much lower production speed, is eliminated. The embossing can proceed over grooving, punching, and the like, because these are produced in a separate step. In addition, the position of the embossing form can also be adjusted automatically to align with the printing. Ultimately, there are many other possible uses of the embossing assembly.

The following additional advantages of the process described above can be derived from what has been said above:

rapid installation of the tools in the machine and short machine down-times, because they have already been adjusted outside the machine;

in-line process saves one work step, which must usually be carried out at a much lower production speed (approximately 8,000 sheets/hour);

embossing can proceed over groovings, punchings, etc., because these are produced in a separate work step; and

fast replacement of Braille text on the same packing without setup times at the punch.

Additional inventive processes can be integrated into the printing press. The embossing tool—ideally designed as matrix and die in the case of blind embossing—is attached to the impression cylinder 1 and to the form cylinder 2 (or blanket cylinder in the printing couple). The form cylinder 2 can be designed with greater strength (increased rigidity) for special requirements. In additional steps, a coating could be applied or some other finishing operation performed. Mechanical deformation of the substrate can be used to enhance or to modify the substrate for further processing (structural embossing). The embossing can also be used to convey information in the form of Braille.

FIG. 4 shows a special embodiment of an embossing form 3 for the production of tactile elements of the Braille type. The process described here is used to install embossing tools which do not necessarily have to be adjusted with the same accuracy as that required for offset printing. Braille printing is one such example where this process can be used.

According to FIG. 4, the matrix or upper embossing form 3A can be mounted on the form cylinder 2 in the form of a universal embossing form. A universal embossing form 3A of this type contains a grid of recesses covering the entire surface to allow the production of the Braille embossing. The die elements or lower embossing form parts 3B required for embossing the Braille text are set up opposite this universal embossing form 3A. There is no need to adjust the position of the embossing form elements 3A on the form cylinder 2. Instead, the universal embossing form 3A can remain clamped in place for several orders, and only the dies or lower embossing form parts 3B have to be replaced. The simplified installation process described here minimizes the required effort.

The arrangement can also be selected in such a way that the universal embossing form 3A serves as the die and is thus provided with the elevations corresponding to the Braille dots. The opposing form is then made up of the matrix elements consisting of the embossing form parts 3B.

Streamlining is possible by the use of an impression cylinder 1 with clamping devices 9. After the order has been completed, the packing plate 4 carrying the properly positioned embossing forms 3B can be removed from the impression cylinder 1 and reused. To facilitate the mounting of the tool on the form cylinder 2 again, the position of the tool on the form cylinder 2 is recorded (by manual markings or by an automatic position sensor). In the case of a repeat order, this configuration can be restored without long setup times. The desired positional accuracy between the embossing and the printing is then achieved by the use of the register possibilities already present in the printing couple or coating module.

FIG. 5 shows a schematic diagram of an arrangement for installing a package consisting of two corresponding embossing form parts.

In the case of an embossing operation, it is necessary for there to be a so-called overfill or clearance 12 present between the embossing motif 11, which is on the die form or lower embossing 3B, and the corresponding recess/opposing form, which is on the matrix or upper embossing form 3A. This overfill makes it possible for the substrate to be embossed to fit itself into the intermediate space between the embossing forms 3A, 3B. Without this overfill, the substrate would tear during the embossing operation.

As a result of the overfill, however, it cannot be excluded that the matrix form 3A and the die form 3B can shift with respect to each other when they are being installed in the printing press, because the way in which the two elements roll with respect to each other is not always exactly the same. A displacement of the embossing forms 3A, 3B with respect to each other, however, would inevitably lead to damage to the substrate. The displacement of the embossing forms 3A, 3B with respect to each other is avoided by providing one of the embossing forms, e.g., the die form 3A, with positioning elements in the form of alignment elements 13. Recesses corresponding to the alignment elements 13 are provided in the matrix form 3B. When engaged, the alignment elements 13 and the recesses have no free space therebetween corresponding to the overfill 12, because exact fixation is, after all, what is required here.

The matrix form 3A and the die form 3B are installed in the following way. The die 3B carries on its rear surface, i.e., the side facing away from the embossing motif 14, an adhesive layer, e.g., double-sided adhesive tape; the alignment elements 13 of the die form 3B are then engaged with the corresponding recesses in the matrix form 3A, which are located on the form cylinder 2 of a coating unit, on the blanket cylinder of a printing couple, or on the impression cylinder 1. Then the assembly is slowly conducted in simple contact or under pressure through the printing gap of the cylinder group. As this happens, the die form 3B is transferred with positional accuracy to the cooperating cylinder, to which, it then adheres. After installation is complete, the alignment element or elements 13 is/are removed by means of a suitable tool such as a knife or milling tool. The embossing tool 3 with its matrix form 3A and its die form 3B is now installed on the cylinders of the printing press and is ready for operation.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A process for affixing an embossing arrangement to a printing press having opposing first cylinder and second cylinder, the embossing arrangement comprising an embossing tool and an opposing tool, the process comprising the steps of:
mounting the embossing tool and the opposing tool together on the first cylinder;
providing a surface of the opposing tool which faces away from the first cylinder with a pressure-sensitive adhesive surface; and
positioning the opposing tool on the second cylinder by rolling the first cylinder over the second cylinder.

2. The process of claim 1, further comprising the step of installing the embossing tool on a packing plate prior to the mounting step.

3. The process of claim 1, wherein the embossing tool comprises a raised-relief printing plate.

4. The process of claim 1, wherein the mounting step comprises clamping the embossing tool, or clamping a packing plate to which the embossing tool is connected, to the first cylinder.

5. The process of claim 1, wherein the mounting step comprises attaching the opposing tool with positional accuracy to the embossing tool, the process further comprising the step of activating the pressure-sensitive adhesive surface of the opposing tool prior to the positioning step.

6. The process of claim 5, wherein the opposing tool is attached to the embossing tool by a spacer element which is removable without leaving any residue.

7. The process of claim 6, wherein the spacer element has two opposite surfaces, at least one of which comprises an adhesive surface.

8. The process of claim 6, wherein one of the embossing tool and the opposing tool comprises embossing elements, the spacer element having respective openings through which the embossing elements extend.

9. An arrangement for embossing in a printing press having a blanket/form cylinder and an impression cylinder, the arrangement comprising:
an embossing tool;
an opposing tool;
a plate mounted on the blanket/form cylinder and carrying the embossing tool; and
an opposing plate removably mounted on the impression cylinder and carrying the opposing tool.

10. The arrangement of claim 9, wherein the opposing plate comprises a packing plate comprising a register.

11. The arrangement of claim 9, further comprising an automatic plate loading device mounted on at least one of the blanket/form cylinder and the impression cylinder for supplying and removing the respective tool and plate.

12. The arrangement of claim 9, wherein one of the embossing tool and the opposing tool comprises a first embossing form carrying Braille dots, and the other of the embossing tool and the opposing tool comprises a second embossing form carrying Braille recesses.

13. The arrangement of claim 12, wherein the embossing tool comprises the first embossing form carrying one of Braille dots and Braille recesses uniformly distributed over its entire surface, the opposing tool comprising the second embossing form carrying at least one section of the other of Braille dots and Braille recesses.

14. A photopolymer embossing plate for embossing a sheet comprising at least one of paper, paper composite, plastic and metal in a sheet-fed rotary printing press, the photopolymer embossing plate comprising:
an embossing form having embossing motifs and alignment elements,
the alignment elements fitting exactly into complementary alignment elements of a corresponding embossing form so that there is no displacement between the first embossing form and the second embossing form.

15. The photopolymer embossing plate of claim 14, wherein each of the embossing motifs fits loosely into a respective recess of the corresponding embossing form so that there is a clearance between said each of the embossing motifs and the respective recess, whereby the sheet is embossed between the first and second embossing forms without being damaged.

16. A process for installing a photopolymer embossing plate in a device, the photopolymer embossing plate comprising a die form having embossing motifs and alignment elements, and a matrix form having corresponding recesses on one side and an adhesive surface on the other side, the process comprising the steps of:
engaging the die form with the matrix form by positioning the embossing motifs and the alignment elements of the die form in the respective recesses of the matrix form;
mounting the matrix form on a first cylinder of the device so that the adhesive surface of the die form faces away from the first cylinder.

17. The process of claim 16, wherein the mounting step comprises rolling the first cylinder over a second cylinder of the device, and introducing the engaged die form and the matrix form into a gap between the first cylinder and the second cylinder so that the matrix form is transferred to the second cylinder while the die form remains on the first cylinder.

18. The process of claim 17, further comprising the step of removing the alignment elements from the die form after the introducing step.
